(19) United States
(12) Patent Application Publication
(10) Pub. No.: US 2011/0035738 A1
(43) Pub. Date: Feb. 10, 2011

(54) METHOD FOR GENERATING AN UPGRADE CAMPAIGN FOR A SYSTEM

(75) Inventors: Maria Toeroe, Montreal (CA); Setareh Kohzadi, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/538,375

(22) Filed: Aug. 10, 2009

(51) Int. Cl. G06F 9/44

(52) U.S. Cl. 717/168

(57) ABSTRACT

A node, computer readable medium and method for generating an upgrade campaign for a system. The method includes receiving a current configuration of the system and a set of modifications to be implemented into the system to arrive at a new configuration of the system, automatically selecting an upgrade procedure for each modification in the set of modifications to be either a rolling upgrade procedure or a single step upgrade procedure, or a combination of these and generating the automatically selected upgrade procedure for each modification of the set of modifications.

### TECHNICAL FIELD

The present invention generally relates to systems, software and methods and, more particularly, to mechanisms and techniques for generating an upgrade campaign for a system.

### BACKGROUND

During the past years computer based services have evolved such that a high availability of these services is required. Achieving service continuity means maintaining customer data and session state without disruption across switchover or other fault-recovery scenarios. The systems providing these services are called high-availability systems (HA systems).

HA systems are systems that are implemented primarily for the purpose of improving the availability of services which the systems provide. Availability can be expressed as a percentage of time during which a system or service is “up.” For example, a system designed for 99.999% availability (so called “five nines” availability) refers to a system or service which has a downtime of only about 0.44 minutes/month or 5.26 minutes/year.

HA systems provide for a designed level of availability by employing redundancy, for example, redundant nodes, which are used to provide the high availability services when various events are taking place, for example, system components fail, software upgrades are performed, etc. For example, if a node running a particular application crashes, an HA system will detect the crash and fail-over the application on another, redundant node. Various redundancy models can be used in HA systems. For example, an N+1 redundancy model provides a single extra node (associated with a number N of primary nodes) that is brought online to take over the role of a primary node which has failed. However, in situations where a single HA system is managing many services, a single dedicated node for handling failures may not provide sufficient redundancy. In such situations, an N+M redundancy model, for example, can be used wherein more than one (M) standby nodes are included and available.

As HA systems become more commonplace for the support of important services such as file sharing, internet customer portals, databases and the like, it has become desirable to provide standardized models and methodologies for the design of such systems. For example, the Service Availability Forum (SAF) has standardized application interface services (AIS) to aid in the development of portable, highly available applications. As shown in the conceptual architecture stack of FIG. 1, the AIS 10 is intended to provide a standardized interface between the HA applications 14 and the HA middleware 16, thereby making them independent of one another. Each set of AIS functionality may be associated with an operating system 20 and a hardware platform 22.

The SA Forum specifications enable the implementation of carrier grade systems and services built with commercial off-the-shelf building blocks. This modular architecture, built on open standard hardware and software, allows for greater reuse and a much quicker turnaround for new product introductions. The reader interested in more information relating to the SAF is referred to www.saforum.org.

An example of a HA system that may undergo an upgrade from configuration A to configuration B is shown in FIG. 2. FIG. 2 shows a cluster 100 having a current configuration A. The same HA system 100 is desired to be upgraded to configuration B. An Availability Management Framework (AMF), which is a software entity defined within the AIS specification, provides availability support for a single logical cluster that consists of a number of cluster nodes and components as shown in FIG. 2. For example, the cluster 100 having current configuration A includes AMF 24, two nodes 26, 28 and four components 30-36. If cluster 100 is upgraded from configuration A to configuration B, the cluster 100 may have the components shown in FIG. 2 under configuration B. Under the new configuration B, cluster 100 may have AMF 24, two nodes 40, 42 and four components 44-50. The components 30-36 and 44-50 each represent a set of hardware and software resources that are being managed by the AMF 24. In a physical sense, components are realized as processes of an HA application. The nodes 26, 28, 40, 42 each represent a logical entity, which corresponds to a physical node on which respective processes managed as AMF components are being run, as well as the redundancy elements allocated to managing those nodes' availability.

Whenever a new configuration needs to be deployed on a HA system, an upgrade campaign is desired to determine a migration path from the current system configuration to this new configuration because the deployment needs to be performed online, i.e., while the HA system continues to provide its services. The migration process itself is called an upgrade campaign in terms of the SAF and its execution may be controlled by the Software Management Framework (SMF). An SMF implementation receives as an input an upgrade campaign specification described as a XML file compliant to an XML schema defined by the SMF specification. The current schema focuses on the upgrade of software entities in the system that are managed by the AMF as the SAF considers that only these entities participate in providing highly available services.

Any guarantee for maintaining the high availability of services during the execution of an upgrade campaign needs to be built into the campaign based on the current configuration of the system and the targeted new configuration. The SMF specification defines some upgrade methods that were designed based on the redundancy models of entities defined by the AMF specification. These are currently the single step upgrade method and the rolling upgrade method. Accordingly, an upgrade campaign specification includes one or more upgrade procedures. Each such procedure deploys some required configuration change either by the single step upgrade method or by the rolling upgrade method. A person that generates an upgrade campaign is faced with the challenge of coming up with an appropriate upgrade campaign specification which applies the SMF specification upgrade methods to different sets of AMF entities in the system, such that these procedures eventually migrate the system from its current configuration to the targeted new configuration without imposing any (or at least minimizing) service outages.

To generate a correct upgrade campaign definition, among other things, it is necessary to identify the upgrade target, which is the set of entities in the current configuration that need to be upgraded or manipulated in different ways to achieve the desired configuration. Typically, the person who produces the upgrade campaign identifies this set of target entities in the system. The trigger for the campaign upgrade may be, for example, the availability of a new version of existing software currently deployed in the system. Thus, entities running this software become potential targets for a software upgrade campaign.

Once the target entities are identified, one needs to identify, based on the redundancy of entities, the upgrade operations necessary to install, remove or change the software in the system, and possibly based on other criteria, what upgrade methods are applicable to each entity. For each applicable upgrade method, the potential impact on the system's services needs to be evaluated, which in turn affects the selection of the upgrade method. That is, generating an appropriate upgrade campaign, particularly in a system having hundreds of software entities that have different dependencies between them, becomes a challenging and iterative task.

Accordingly, it would be desirable to provide devices, systems and methods that are capable of generating such an upgrade campaign.

### SUMMARY

According to one exemplary embodiment, there is a method for generating an upgrade campaign that includes upgrade procedures for a system. The method includes a step of receiving a current configuration of the system and a set of modifications to be implemented into the system to arrive at a new configuration of the system, wherein the current configuration includes a configuration of current entities and a configuration of types of the current entities; a step of automatically selecting an upgrade procedure for each modification in the set of modifications to be either a rolling upgrade procedure or a single step upgrade procedure, or a combination of these based on one or more of: the current entities, the types of the current entities, entities of the new configuration, types of the entities of the new configuration, and relationships between the current entities and the entities of the new configuration; and a step of generating the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.

According to still another exemplary embodiment, there is a computer readable medium including computer executable instructions, where the instructions, when executed, implement a method for generating an upgrade campaign for a system. The method includes a step of receiving a current configuration of the system and a set of modifications to be implemented into the system to arrive at a new configuration of the system, wherein the current configuration includes a configuration of current entities and a configuration of types of the current entities; a step of automatically selecting an upgrade procedure for each modification in the set of modifications to be either a rolling upgrade procedure or a single step upgrade procedure or a combination of these, based on one or more of: the current entities, the types of the current entities, entities of the new configuration, types of the entities of the new configuration, and relationships between the current entities and the entities of the new configuration; and a step of generating the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.

According to yet another exemplary embodiment, there is a node configured to generate an upgrade campaign for a system, where the upgrade procedures are executed by a Software Management Framework (SMF). The node includes a processor configured to receive a current configuration of the system and a set of modifications to be implemented into the system to arrive at a new configuration of the system, automatically select an upgrade procedure for each modification in the set of modifications to be either a rolling upgrade procedure or a single step upgrade procedure or a combination of these, and generate the automatically selected upgrade procedure for each modification of the set of modifications.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a software/hardware architecture of the HA system;

FIG. 2 is a schematic diagram of a current configuration and a desired new configuration of the HA system;

FIG. 3 is a schematic diagram showing relationships between various entities and corresponding configurations according to an exemplary embodiment;

FIG. 4 is a schematic diagram of the HA system having multiple service groups, service units, components, and service instances;

FIG. 5 is a schematic illustration of a method for generating an upgrade campaign for a system from various upgrade actions according to an exemplary embodiment;

FIG. 6 is a flowchart illustrating steps for computing additional upgrade actions according to an exemplary embodiment;

FIG. 7 is a flowchart illustrating control flow for computing single step upgrade procedures according to an exemplary embodiment;

FIGS. 8-14 are flowcharts illustrating steps for computing various single step and rolling upgrades procedures according to various exemplary embodiments;

FIG. 15 is a flowchart illustrating steps for determining upgrade actions according to an exemplary embodiment; and

FIG. 16 is a schematic diagram of a computing system.

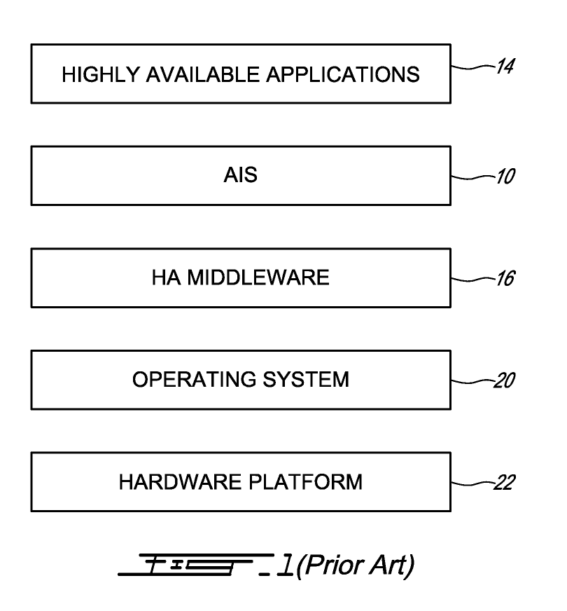

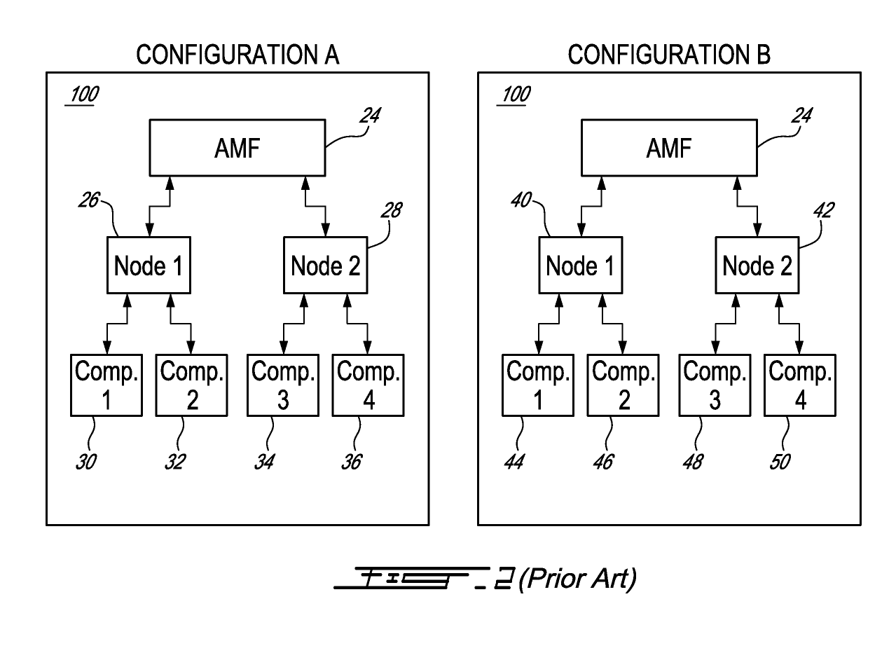

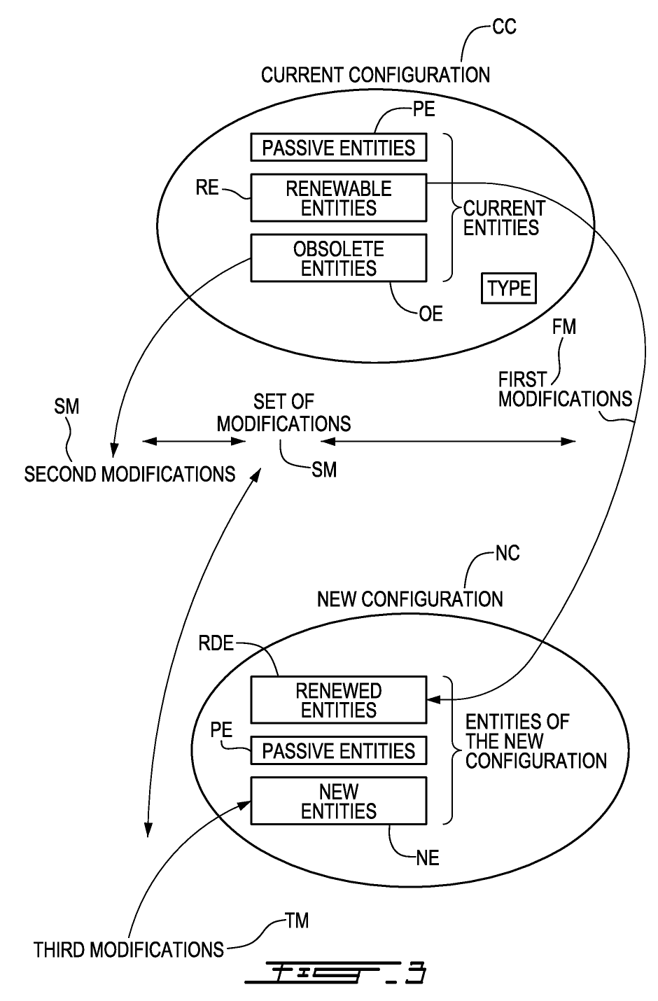

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of HA systems. However, the embodiments to be discussed next are not limited to these systems but may be applied to other systems that need from time to time to have their configuration changed while providing reliable services.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment, a method for generating an upgrade campaign, in the context of SAF compliance systems, in particular those controlled by AMF, and relying on the deployment methodology defined by the SAF SMF specification is discussed next. The method targets the generation of an upgrade campaign that includes rolling and single step upgrade procedures, which are capable of upgrading (or downgrading) existing components and service units of a current configuration to a new configuration. The upgrade campaign may remove currently deployed software entities from the system and/or may deploy new software entities in the system in a manner that has minimal impact on the services provided by the system.

The rolling upgrade and the single-step upgrade procedures as defined as follows by the SMF specifications. The rolling upgrade iterates the same upgrade step over a set of similar deactivation-activation unit pairs one by one until the entire upgrade scope is covered. A unit pair includes an activation unit and a deactivation unit. The activation unit may include a group of software entities that are brought into service after an upgrade operation. The deactivation unit may include a group of software entities that are taken out of service before the upgrade operation. One advantage of the rolling upgrade is that it takes out of service one deactivation unit at a time for upgrade while the rest of the system is providing the service. By selecting the deactivation and activation units in accordance with the redundancy model, the rolling upgrade ensures that there will be no service outage, or it will be limited to the outage caused by a single deactivation unit during the execution of the upgrade procedure (provided that failures do not reduce the number of redundant entities). A feature of this method is that entities of different versions of the base entity type coexist within the system without any restrictions; therefore, they must be able to collaborate for high-availability purposes. For example, they may need to act as peer entities within the same redundancy schema protecting the same service, which may require them to exchange state information.

The single-step upgrade means that the upgrade scope is not divided into multiple deactivation activation unit pairs. There is only one such pair. The upgrade step is applied to all software entities in the upgrade scope simultaneously by taking out of service the entire deactivation unit at the beginning of the step and then re-activating the entire activation unit after the completion of the upgrade step. Since the upgrade is carried out simultaneously on all software entities of the upgrade scope, none of them can provide service during this operation. This may cause service outage for all service instances that rely exclusively on the entities involved in such an upgrade. The advantage or the reason why this method is still applied is that it eliminates the compatibility issues among the entities of the upgrade scope. This is also the simplest upgrade method to implement. It is appropriate for entities that are not providing services any more and need to be removed from the deployment configuration or for new entities that need to be added to the deployment configuration.

According to another exemplary embodiment, the single step and rolling upgrade procedures are defined as follows. An upgrade step is a sequence of manipulations carried out in order to upgrade a set of entities. Three sets of entities may be involved:

entities that are taken out of service for the time of this upgrade—the SMF specification defines them as the deactivation unit. This set may be empty;

entities that are being upgraded: removed, added and/or renewed; and

entities that are put back in service after the completion of the upgrade—the SMF specification defines them as the activation unit. This set may also be empty.

The single step procedure is composed of a single upgrade step. There is no requirement or limitation on these three sets and their relations. Services provided exclusively by the entities included in the deactivation unit are not provided for the time of the upgrade step. Manipulations and the entities need to be explicitly specified for such a step. SMF executes such a procedure exactly as described in the upgrade campaign.

The rolling upgrade procedure is composed of a series of similar upgrade steps executed in sequence, one step at a time. They are similar because the same manipulations are performed on redundant sets of entities each time taking out of service a single set. Entities in the three sets of the first step are functionally equivalent to the sets of the second step and so on, because these are entities that are in redundancy to protect some services. As a result, the services are provided while such a procedure is being executed (e.g., entities in the deactivation unit of the second step provide the services while entities in the deactivation unit of the first step are taken out of service and vice versa.)

Using similarities, such a series of steps is defined through a template and handled as a single rolling upgrade procedure. The exact content and order of the execution of these steps is resolved at execution time by SMF.

The SMF specification imposes further restrictions because of this template approach. That is, the deactivation unit and the activation unit need to be equivalent, i.e., the same set of entities. The manipulation of the entities, i.e., the upgrade, can only be a renewal.

Prior to describing this and other upgrade methods in more detail, formal definitions of the parts of the HA system are introduced next. On the service side, the following configuration elements are introduced:

Component Service Instance (CSI): the portion of a service that a component is capable of providing;

Component Service Type (CST): the type of a CSI;

Service Instance (SI): set of CSIs and it is provided by a service unit; and

Service Type (ST): type of SIs and defines the set of CSTs of CSIs which may compose the SIs of this type.

The method according to an exemplary embodiment assumes that services of entities that currently exist and that remain in the system do not change during the upgrade. Therefore, when upgrading service units from their current type to a different type, the upgrade should guarantee that the upgraded service units are still capable of serving the CSIs that compose the SIs protected by them. This condition is ensured by verifying that the CSTs of the CSIs are provided by the component types of the new service unit type.

On the provider side, the following configuration elements are introduced:

Component: the smallest entity which an AMF controls and therefore, the smallest entity that can be upgraded. Components may be selected based on their type or their Relative Distinguished Names (RDN);

Component Type (CT): specifies the common properties of components that run the same software. Also, CT defines the set of CSTs that a component of this type can provide.

Component RDN (ComponentRDN): the name of a component relative to the parent service unit. To be able to address components using the rolling upgrade method, it is preferable that their name is relative to their parent service unit. Therefore, equivalent components in different service units of a service group have the same RDN;

Service Unit (SU): groups a set of components that are able to provide one or more service instances. A service unit can be selected for upgrade by its type or RDN;

Service Unit Type (SUT): specifies the set of component types that should be used to compose an SU. It also specifies the service types that the service units of this type can provide;

Service Unit RDN (SURDN): a unique name of a service unit in the service group;

Service Group (SG): includes a set of service units. The service group provides a set of SIs, which are assigned to different SUs in a redundant manner for ensuring high availability services;

Service Group Type (SGT): specifies the set of service unit types that can make up a service group of the type and the redundancy model these SGs use;

Node: a logical entity that maps to an operating system instance running on a physical node. The node may host a set of service units. Software may be installed on and removed from nodes;

Node Group: a set of nodes that can host service units of a given service group; and

Software: instructions associated with some component types that need to be installed on (removed from) a node in order to be able to (disable the) run (of) a component of any of those component types. The software installation and removal that can be performed without affecting any of the entities in the system is called online installation or removal. If the installation/removal may affect any entity in the system, the software requires offline installation/removal. The set of impacted entities may be the service unit or the entire node. For simplicity, the method is presented with the assumption that the entire node is impacted.

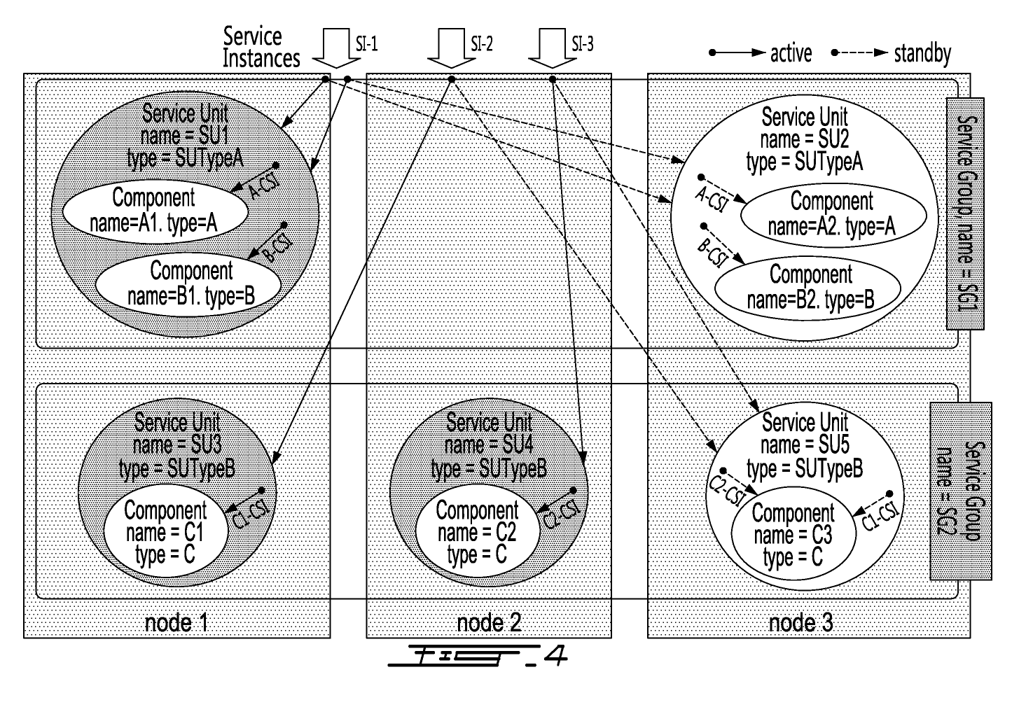

As some entities are upgraded in the current configuration to generate the new configuration, or some entities are removed from the current configuration, or some entities are added in the new configuration, the following terminology is introduced for labeling these entities. It is noted that any permutation of adding, renewing and removing entities may be used, with some of the operations missing, appearing repeatedly or being interleaved one with each other. FIG. 3 shows the current configuration CC, the new configuration NC and a set of modifications SM that take the current configuration CC to the new configuration NC. The current configuration CC includes renewable entities RE, which are upgraded based on first modifications FM to renewed entities RDE, which are part of the new configuration NC. The current configuration CC also includes passive entities PE, which are not modified during the upgrade. Also, the current configuration CC includes obsolete entities OE, which are removed from the system based on second modifications SM. The new configuration NC includes the passive entities PE, which are not affected by the upgrade, renewed entities RDE which correspond to the renewable entities RE of the current configuration CC, and new entities NE, which are added to the new configuration NC by third modifications TM. The new entities NE do not exist in the current configuration CC. The first modifications FM, the second modifications SM, and the third modifications TM are part of the set of modifications SM. All the entities of the current configuration are the current entities and all the entities of the new configuration are the entities of the new configuration. The set of modifications SM may include only the first modifications FM, only the second modifications SM, only the third modifications TM, or any combinations of the above.

Having introduced the above terminology, the description of the method for generating the upgrade campaign is now discussed. According to an exemplary embodiment, an input of the method of the upgrade campaign generation includes the current configuration of the system that needs to be upgraded, i.e., the configuration of the current AMF entities in the system and the configuration of current entity types in the system. Optionally, an additional configuration of entities and entity types that need to be added to the current configuration, i.e., to be deployed as part of the target configuration, may be supplied as input. In addition, the modifications to the current system configuration are provided as input. These modifications may be presented to include: a set of the current or source entities (e.g., AMF components and service units that may have a name and a type to which they belong to), which are part of the current configuration, a set of the target entities (typed AMF components and service units), which maybe part of either of the current or the additional configuration, and a list of nodes to be impacted by the upgrade campaign.

Based on the above input, according to an exemplary embodiment, the method may check first whether the provided modifications are consistent and complete. The method then generates an additional set of modifications for entities that need to be upgraded due to dependencies associated with one or more entities that are targeted by the upgrade campaign. The resulting target configuration is calculated and verified for validity. If any inconsistency is found, the input may be rejected.

Next, the method identifies, based on the now complete set of modifications, what current entities need to be upgraded by the rolling upgrade method and what entities need to be upgraded by the single step upgrade method. This choice is made based, in part, on the source/target entity sets. According to one exemplary embodiment, if any of these sets is empty, the upgrade, at least partially, is performed by the single step upgrade method.

The sets of entities that need to be upgraded by the single step upgrade method may further be classified based on the targeted entity's type. For AMF components that are added to or removed from service units of a service group, the method generates a series of single step procedures that imitate the rolling upgrade method. This approach is taken in order to protect the services provided by the service group receiving the additional components. The imitation process is explained next as follows. Rolling upgrade is a series of implied single step upgrades. These single steps are calculated by SMF at the moment the upgrade is performed based on a compact template based description, which provides a selection criteria for the elements of the series. For example, the template indicates an SG, and SMF calculates a single step upgrade for the upgrade of each SU within the SG. By imitation it is understood than rather then relying on SMF, the upgrade campaign explicitly specifies such a series of upgrade steps, i.e., there is a single step procedure explicitly defined for each SU of an SG, and these single step procedures are in sequence as SMF would serialize them within the rolling procedure. Similar availability can be achieved, but SMF is not required to be aware of the situation and to do any of the calculations.

For other entities that are upgraded by the single step method, depending on the software installation and removal requirements (i.e., offline or online installation or removal), additional rolling procedures may be required as discussed next. If any of the impacted software requires offline installation or offline removal, which means that this action may affect other running entities in the system, the method separates the software installation or removal from the addition/removal of the entities. The method would then add rolling upgrade procedures for the software installation/removal part, while the entities themselves are added/removed with a single step upgrade procedure. It is noted that the software undergoing the rolling upgrade procedure is associated with the entity undergoing the single step upgrade procedure, and therefore, the ordering of the procedures is relevant, i.e., entities are removed by the single step procedure before their software is removed by the rolling upgrade procedures. If entities and their software are to be added, this ordering is reversed.

To improve the method, the software installation/removal procedures may be merged together, so that the entire software of a node may be installed and/or removed in a single step and therefore, the node is taken out of service only for the minimal necessary time.

Next, the modifications are processed according to their classification and the actual upgrade procedures are generated to compose the upgrade campaign. The following description summarizes steps performed by the method: (1) series of single step upgrade procedures are generated based on the modifications that remove components from the current configuration of the system; (2) series of single step upgrade procedures are generated based on modifications that remove service units (and enclosing entities) from the current configuration of the system (if software requires only online removal, the procedure includes software removal as well); (3) rolling upgrade procedures are generated based on modifications that remove and/or add software for any entity added to or removed from the current configuration using any offline action; (4) single step upgrade procedures are generated based on modifications that add service units (and enclosing entities) to the current configuration (if software requires only online installation, the procedure includes software installation as well); (5) series of single step upgrade procedures are generated based on modifications that add components to the current configuration; and (6) rolling upgrade procedures are generated based on modifications that change the configuration of existing entities (e.g., change their type. It is noted that the associated software removal/installation is included in these procedures).

The generated upgrade campaign can be provided as input to the SMF of the system running the AMF configuration. Based on this initial input, the SMF executes the upgrade campaign to upgrade the system from the current configuration to the new (target) configuration. More details about the method that generates the upgrade campaign are provided next.

A number of utilities may be used to resolve relations between the different configuration elements. Examples of such utilities are:

ParentSUTypes(ct): this utility returns the set of service unit types that contain components of type ct;

ParentSGTypes(sut): this utility returns the set of service group types that contain service units of type sut;

ComponentTypes(sut): this utility returns the set of component types that make up the service unit type sut;

Max(ct, sut): this utility returns the maximum number of components of component type ct that are allowed to be present in a service unit of type sut;

SUTypes(sgt): this utility returns the set of service unit types that can be used to make up a service group of type sgt; and

nodeGroup(sg): this utility returns the set of nodes that may host service units from service group sg.

Based on these and other utilities, upgrade actions that are part of the upgrade campaign specify modifications (i.e., configuration changes) that the user would like to implement by the execution of the upgrade campaign. These modifications are specified as tuples (as an upgrade action is a formal description of a modification) of the following format:

### Source, Target, ChangeSet, NodeList

Source and Target are entities of the configuration and may be specified either by their type (SUT or CT) or by their RDN (SURDN or ComponentRDN). When the type is specified, all entities of that type are selected in a configuration. If applicable, the identification of the RDN would reduce the set of entities of a selected type to the subset that have the specified RDN. The interpretation of the RDN depends on the operation, i.e., add, remove or type change, and/or the category of the entity. The change set (ChangeSet) may also be used to refine the entity selection. Namely, the change set may specify the SGs, within which the type/RDN selection is applied.

In the following, different upgrade action options are discussed for different operations. In all cases, the Source, ChangeSet and NodeList are part of the system configuration that needs to be upgraded, i.e., the current configuration. The Target could be either part of the current configuration or part of the additional configuration provided by the user, depending on the operation. The NodeList={nodes} element specifies the set of nodes on which the software installation and/or removal needs to be performed for a particular Source and Target.

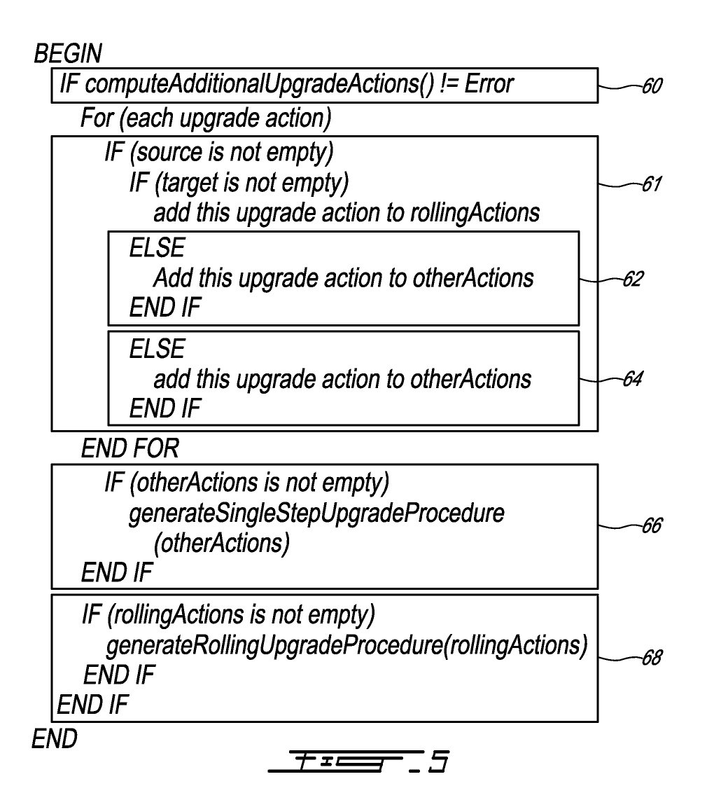

For a better understanding of the configuration elements that are changed by the above noted tuples, the following example shown in FIG. 4 is discussed. FIG. 4 is similar to FIG. 4.1 of F. Tam, Ph.D. thesis, “Service Availability Standards For Carrier-Grade Platforms: Creation and Development in Mobile Networks,” Tampere University of Technology, Finland, the entire content of which is incorporated herein by reference. FIG. 4 shows a cluster with three interconnected nodes 1, 2, and 3. Node 1 is shown including components A1, B1, and C1. The service provided by this cluster is configured as two service groups, SG1 and SG2. SG1 includes two service units, SU1 and SU2 of type SUTypeA. SU1 includes two components, A1 and B1 of type A and B, respectively. These two components may represent software processes that are running on node 1. SU2 includes two different instances, A2 and B2 of types A and B, respectively, and run on node 3. SG2 is made up of three services units, SU3, SU4, and SU5 of type SUTypeB, each of which has one component of type C running on nodes 1, 2, and 3.

The workloads of this cluster are represented by service instances SI-1, SI-2 and SI-3. SI-1 is an aggregate of the component service instances A-CSI and B-CSI, which can be served by components of types A and B. SI-2 and SI-3 have only one service instance CSI each, C1-CSI and C2-CSI respectively both belonging to the same C CS type. For each service instance, there is typically one service unit that handles the live workload and another service unit that acts as a standby. Since the SIs are decomposed to their constituent CSIs, the corresponding status is carried to the CSI level. The possible runtime assignment of the active and standby statuses are indicated as solid and dashed arrows, respectively, in FIG. 4.

Having this understanding of the configuration elements of the HA system according to this exemplary embodiment, the various operations indicated by the tuples are discussed next. First, a type change operation is discussed. Table 1 is illustrative of various scenarios in which an entity is upgraded. Each row in Table 1 shows a possible variant of the upgrade actions for “changing type” scenarios. The changes are specified as tuples.

TABLE 1

| Source | Target | Change Set | Node List |
|---|---|---|---|
| SUT1 | SUT2 | SG | {nodes} |
| CT1 | CT2 | SG | {nodes} |
| SURDN | SUT2 | SG | {nodes} |
| ComponentRDN | CT2 | SG | {nodes} |

The tuple in the first row indicates that the SUs of SG of current type SUT1 need to be upgraded to type SUT2. The tuple also indicates the need to replace, on the nodes that are specified in the {nodes} list, the old software with the new software, i.e., software bundles referenced by component types in SUT1 need to be removed and software bundles references by component types in SUT2 need to be installed on these nodes as the software on other nodes of the SG needs to be kept intact. For example, with reference to FIG. 4, SG of the first row in Table 1 corresponds to SG1 of FIG. 4, SUT1 of the first row of Table 1 corresponds to SUTypeA of FIG. 4 and SUT2 of the first row of Table 1 corresponds to a new SUTypeC not present in FIG. 4. This new SU type is introduced by the upgrade. NodeList of Table 1 includes node1 and node3 of FIG. 4.

In the second row of Table 1, the tuple indicates that all components of type CT1 in SG need to be upgraded to CT2. Similarly, as in the first case, this tuple indicates the replacement of the old software of CT1 with the new one of CT2 on the nodes that are specified in the NodeList={nodes}. For example, with reference to FIG. 4, SG of the second row in Table 1 corresponds to SG1 of FIG. 4, CT1 of the second row of Table 1 corresponds to component type A of FIG. 4 and CT2 of the second row of Table 1 corresponds to a new component type X, not shown in FIG. 4.

In the third row of Table 1, the tuple, which specifies as source a particular SU within SG by its name SURDN, results in an upgrade similar to the tuple in the first row. That is, it targets all SUs of the SG and upgrade the SUs to SUT2. This is due to the consistency requirement that all SUs of an SG need to be of the same type. For example, still with reference to FIG. 4, SG of the third row in Table 1 corresponds to SG1 of FIG. 4, SURDN of the third row of Table 1 corresponds to SU1 of FIG. 4 and SUT2 of the third row of Table 1 corresponds to a new SUTypeC not shown in FIG. 4. Due to consistency reasons, SU2 of FIG. 4 also needs to be upgraded. The nodes affected by this upgraded are node1 and node3 of FIG. 4, and these two nodes are the elements of NodeList in Table 1.

In the forth row of Table 1, the tuple targets the component with the specified RDN in each SU of SG and upgrades them to CT2. Note that by providing the RDN of the component, the type of the component is also identified. The upgrade will also replace the old software with the new software on the nodes specified in the NodeList={nodes}. For example, still with reference to FIG. 4, SG of the fourth row in Table 1 corresponds to SG1 of FIG. 4, ComponentRDN of the fourth row of Table 1 corresponds to Component name A1 of FIG. 4 and CT2 of the fourth row of Table 1 corresponds to new component type X, not shown in FIG. 4. Component name A1 identifies the component type A, and for consistency all corresponding components of type A in each SU need to be upgraded to the specified new type X.

Examples for removing entities from the current configuration are shown in Table 2. Table 2 shows that the Target is empty, i.e., entities are to be removed from the current configuration.

TABLE 2

| Source | Target | Change Set | NodeList |
|---|---|---|---|
| SUT | 0 | SG | {nodes} |
| CT | 0 | SG | {nodes} |
| SURDN | 0 | SG | {nodes} |
| ComponentRDN | 0 | SG | {nodes} |

In the first row of Table 2, the tuple specifies an SUT in an SG to be removed (target is empty). Because each SG has only one SUT, this action will result in removing the whole SG from the current configuration. If any node is specified in the {nodes}, the software referenced by any component type in SUT will be removed from all these nodes. For example, with reference to FIG. 4, SG of the first row in Table 2 corresponds to SG1 of FIG. 4, SUT of the first row of Table 2 corresponds to SUTypeA of FIG. 4 and this action specifies the removal of the whole SG1 from the configuration.

In the second row of Table 2, the tuple acts to remove all components of the specified type within SG. The tuple will also uninstall related software from the nodes that are in the {nodes} set. For example, still with reference to FIG. 4, SG of the second row in Table 2 corresponds to SG1 of FIG. 4, CT of the second row of Table 2 corresponds to component type B of FIG. 4 and this action specifies the removal of component B1 from SU1 and component B2 from SU2 in FIG. 4.

In the third row of Table 2, the tuple indicates the removal of the specified SU together with its components from the configuration of the SG. It also specifies the removal of related software bundles from the indicated nodes. The nodes will be removed from the SG's node group as appropriate. For example, still with reference to FIG. 4, SG of the third row in Table 2 corresponds to SG2 of FIG. 4, SURDN of the third row of Table 2 corresponds to SU4 (suppose that we want to remove node 2 from the configuration) of FIG. 4 and this action specifies the removal of SU4 and its component C2 from the configuration. Nodelist includes node2 from which the software will be removed too. As a result of this modification, SG2 in FIG. 4 would remain with two SUs, i.e., SU3 and SU4.

In the fourth row of Table 2, the tuple specifies the removal of components with the specified RDN from all SUs of the SG and the uninstallation of related software bundle from the specified nodes of the {nodes}. For example, still with reference to FIG. 4, SG of the fourth row in Table 2 corresponds to SG1 of FIG. 4, ComponentRDN of the fourth row of Table 2 corresponds to component name B1 of FIG. 4 and this action specifies the removal of B1 from the configuration. For consistency, component name B2 also needs to be removed as having the same type B as component name B1 but in SU2.

Examples for addition of entities to the current configuration are shown in Table 3. Table 3 shows that the Source field is empty, i.e., new entities are added the current configuration.

TABLE 3

| Source | Target | Change Set | NodeList |
|---|---|---|---|
| 0 | SUT | SG | {nodes} |
| 0 | SURDN | SG | {nodes} |
| 0 | ComponentRDN | SG | {nodes} |

The addition of entities requires that their complete configuration is provided by the user. This should include both the configuration of entities and their entity types as appropriate. For addition of entities, the source entity set is empty. The selection of target entities is made in the configuration additionally provided to the system's current configuration. Note also that components to be added cannot be specified by their type only as these new components need to be encapsulated within an SU for AMF.

In the first row of Table 3, the tuple specifies the addition of a new SG, SUs of type SUT and their components. This may also imply the addition of a complete new application with all its SGs. If there is any node specified, the upgrade campaign would also install the necessary software on those nodes. For example, with reference to FIG. 4 and assuming that FIG. 4 does not include SG2 and this group is the intended result of the upgrading action, SG of the first row in Table 3 corresponds to SG2 of FIG. 4, SUT of the first row of Table 3 corresponds to SUTypeB. In addition, one needs to specify the configuration of SG2, i.e., having SU3, SU4, and SU5 and their components C1, C2, and C3. The node list includes elements node1, node2, and node3 and this action specifies the addition of the whole SG2 to the configuration.

In the second row of Table 3, the tuple will add only one SU to the SG with the name SURDN. Accordingly, the SG currently exists in the configuration. The upgrade campaign will also install the related software on the nodes that are specified in the {nodes}. The nodes will be added to the SG's node group as appropriate. For example, still with reference to FIG. 4, SG of the second row in Table 3 corresponds to SG1 of FIG. 4, SURDN of the second row of Table 3 corresponds to new SU6 (not shown in FIG. 4) which will be added as a result of this upgrade action and the node list includes element node2. The additional configuration needs to specify the structures of SU6, for example, its components A3 and B3 (not shown in FIG. 4).

In the third row of Table 3, the tuple specifies the addition of components with the specified RDN to all SUs of the SG. The SG is supposed to exist in the current configuration. The upgrade campaign will install the related software bundle on the nodes of the {nodes} set. For example, still with reference to FIG. 4, SG of the third row in Table 3 corresponds to SG2 of FIG. 4, ComponentRDN of the third row of Table 3 corresponds to new component name D. This action would add new component name D in each SUs of SG2 as D1, D2 and D3. The configurations of these components need to be provided as additional configuration.

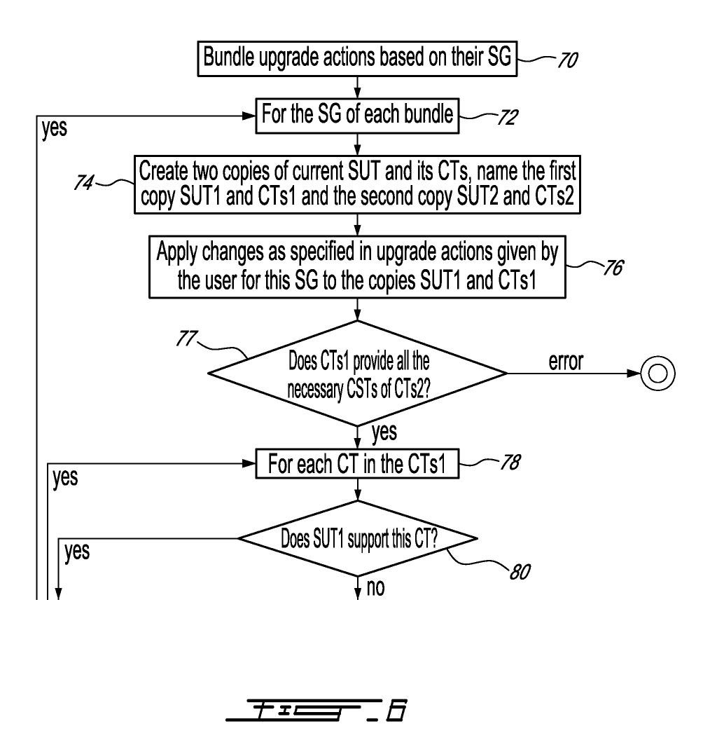

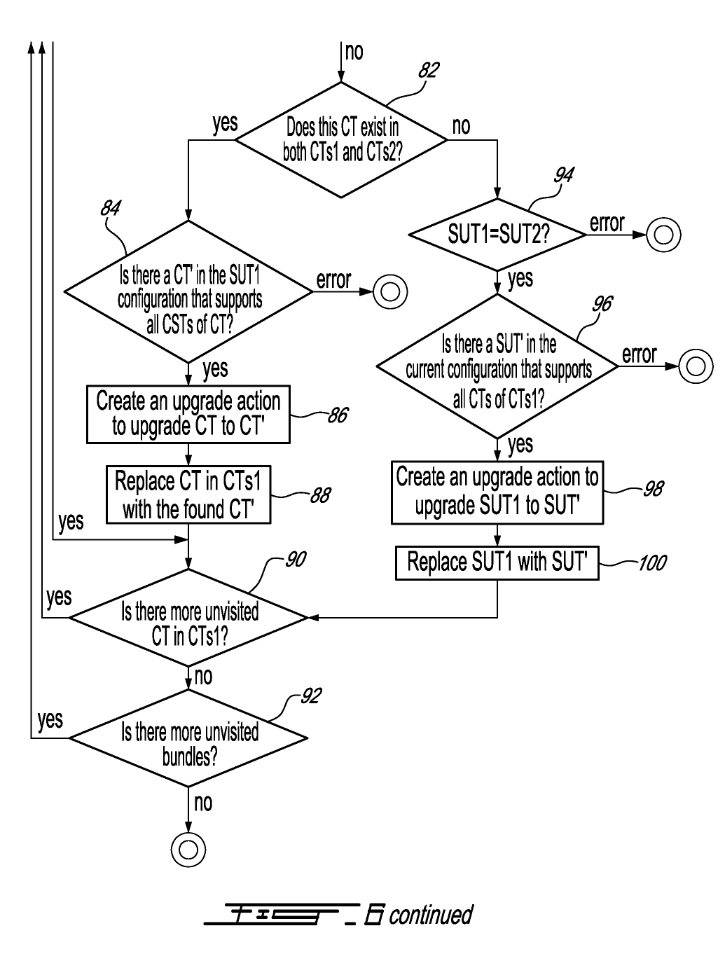

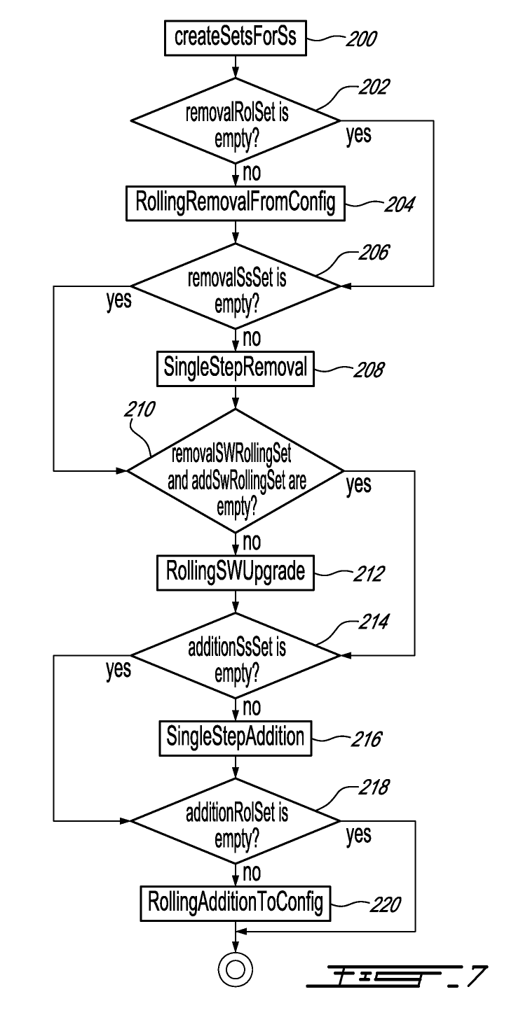

After the input to the upgrade campaign generation method is provided, the steps illustrated by FIG. 5 are performed. The order of some of the steps may be modified as needed. The steps are shown next to a pseudo-code that indicates various procedures that are called in. Each of the procedures called by the main method is further described and illustrated with a corresponding flowchart in FIGS. 6-15.

The method calls in step 60 a computeAdditionalUpgradeActions procedure, which may generate additional upgrade actions that may be necessary for consistent configuration changes. In step 61, the algorithm determines whether either the source or the target set is empty. In case that neither set is empty, the algorithm determines an upgrade action that is added to a set rollingActions. It is noted that the fact that neither the source nor the target are empty suggests that a modification of the current configuration does not include addition or removal of entities.

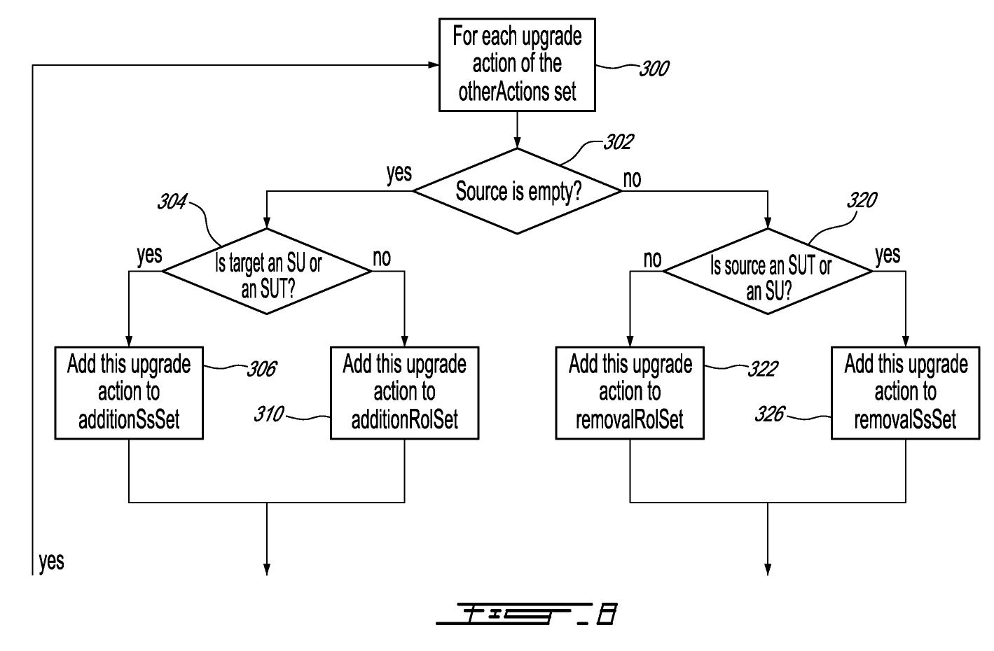

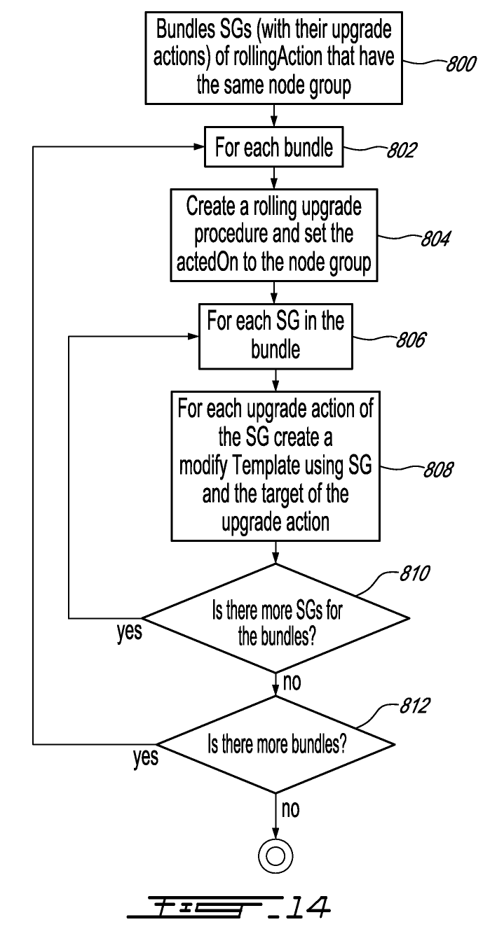

However, if it is determined in step 61 that either the source or the target is empty, this suggests that either removal or addition of entities is present. If the target set is empty, i.e., removal of current entities, step 62 determines an upgrade action that belongs to set otherActions. If the source set is empty, i.e., addition of entity, step 64 determines an upgrade action that belongs to set otherActions. Further, the method determines in step 66 whether the set otherActions is empty. If this set is not empty, the method generates the single step and potentially some additional rolling upgrade procedures, which are discussed with regard to FIG. 7. In step 68 the method determines whether the rollingActions is empty. If this set is not empty, the method generates the rolling upgrade procedures, which are discussed below with regard to FIG. 14.

FIG. 6 illustrates the calculation performed by procedure computeAdditionalUpgradeActions noted in step 60. This procedure receives as input the initial configuration of the system, any additional configuration and the upgrade actions provided by the user that specify different configuration changes the user would like to deploy. The procedure outputs additional upgrade actions that are necessary to preserve the system consistency. If an inconsistency is found and this inconsistency cannot be corrected, the procedure fails.

Thus, this procedure sorts and processes the upgrade actions specified by the user SG by SG. In addition, the procedure may verify whether the SG configuration would remain consistent after performing an upgrade deploying these changes. In cases when the upgrade action set is incomplete, additional upgrade actions are calculated. In case that an inconsistency is found and the inconsistency cannot be corrected, the upgrade actions are rejected and the procedure fails.

More specifically, FIG. 6 shows that in step 70 the method groups upgrade actions based on their SG. In step 72, the SG of each bundle is selected and in step 74 two copies of current SUT and its CTs are created, i.e., the first copy is SUT1 and CTs1 and the second copy is SUT2 and CTs2. In step 76, changes are applied as indicated in the upgrade actions provided by a user to the copy SUT1 and CTs1. In step 77, it is verified that the new set of component types CTs1 supports all the necessary CSTs of the old set contained in CTs2. If it is not the case, an error is generated, otherwise in step 78, the method selects a CT from the CTs1 and in step 80 it is determined whether SUT1 supports the selected CT. If the SUT1 does not support the selected CT, the method advances to step 82. Otherwise, the method advances to the next CT in the CTs1.

In step 82 it is evaluated whether the selected CT exists in both CTs1 and CTs2. If the answer is yes then an inconsistency has been found. To correct the inconsistency, it is determined in step 84 whether there is a component type (CT') in the configuration of SUT1 that supports the CSTs of the selected CT. If the answer is no, an error is produced. If the answer is yes, an upgrade action is created in step 86 to upgrade the selected CT to the found CT′. In step 88, the selected CT in the CTs1 is replaced with the found CT′. The method advances to step 90 to consider the next CT in the CTs1. If no additional CT is to be considered, the method advances to step 92, in which a next SG is to be considered. If no SG is left the method stops. If other SGs are to be considered, the method returns to step 72.

However, if the answer in step 82 is no, the method advances to step 94, in which it is determined whether SUT1 is the same as SUT2. If the answer is no, an error is generated as the user input contains contradictory values. If the answer is yes, the method advances to step 96, in which it is determined whether a service unit type SUT′ exists in the current configuration that supports all CTs in CTs1. If the answer is no, an error is produced. If the answer is yes, the method advances to step 98, in which an upgrade action is created to upgrade SUT1 to SUT′. Then, in step 100 the SUT1 considered above is set to the found SUT′ and the method advances to step 90, which was already discussed.

Next, the method for generating a single step upgrade procedure, which was introduced in step 66 of FIG. 5, is discussed with regard to an exemplary embodiment shown in FIG. 7. The input for this procedure is the otherActions set, which is the set of upgrade actions that add or remove entities. It is noted, as already discussed above, that the upgrade actions may add or remove entities or may change entities. This method of generating single step upgrade procedures invokes various sub-methods, depending on the upgrade actions contained in the otherActions set.

Some of these Sub-Methods are:

RemovalRolSet, which contains upgrade actions that remove components;

RemovalSsSet, which contains upgrade actions that remove entities other than components;

RemovalSWRolSet, which contains upgrade actions that remove software in a rolling manner;

AddSWRolSet, which contains upgrade actions that add software in a rolling manner;

AdditionSsSet, which contains upgrade actions that add entities other than components; and

AdditionRolSet, which contains upgrade actions that add components.

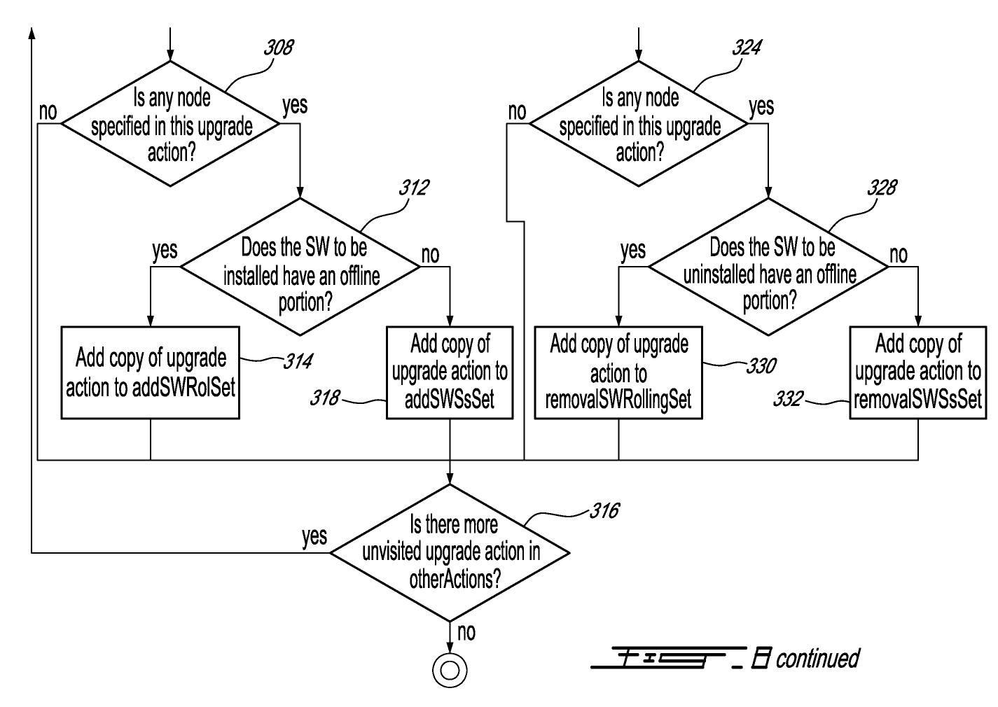

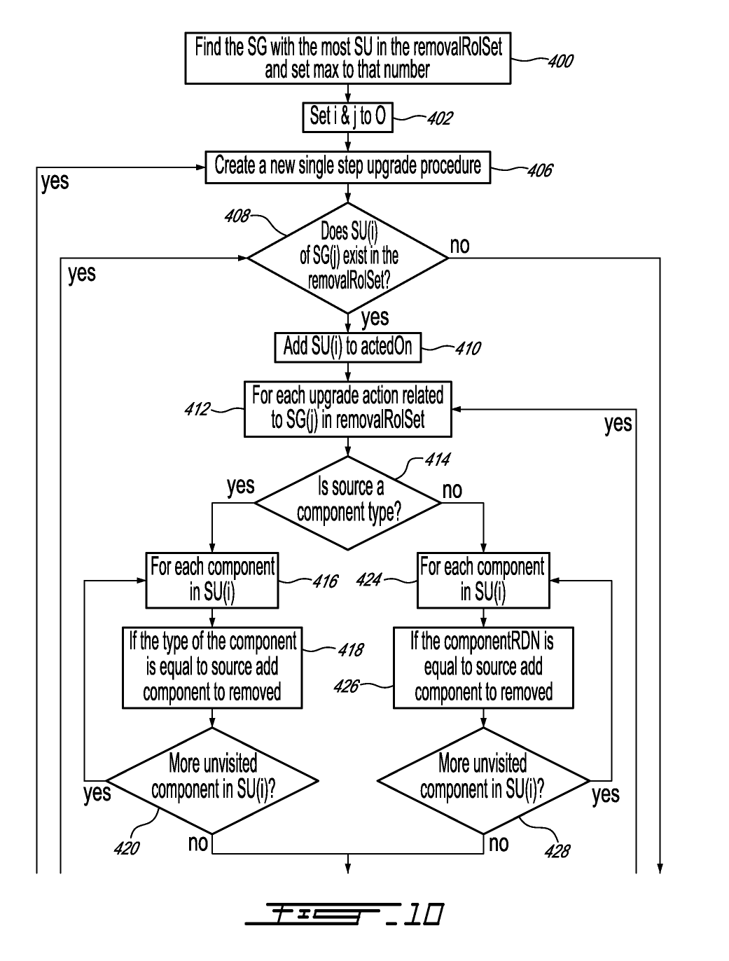

The sets of Actions that are modified by the above procedure are created by a createSetsForSs procedure in step 200 in FIG. 7. This procedure is discussed later in more detail with respect to FIG. 8. After the sets are formed, the method advances to step 202 in FIG. 7 for verifying whether the set of upgrade actions that remove components is empty. If the answer is no, the method advances to step 204. If the answer is yes, the method advances to step 206. In step 204, a RollingRemovalFromConfig procedure (to be discussed later with regard to FIG. 10) generates an appropriate series of single step upgrade procedures to remove components based on the upgrade actions of the input sets.

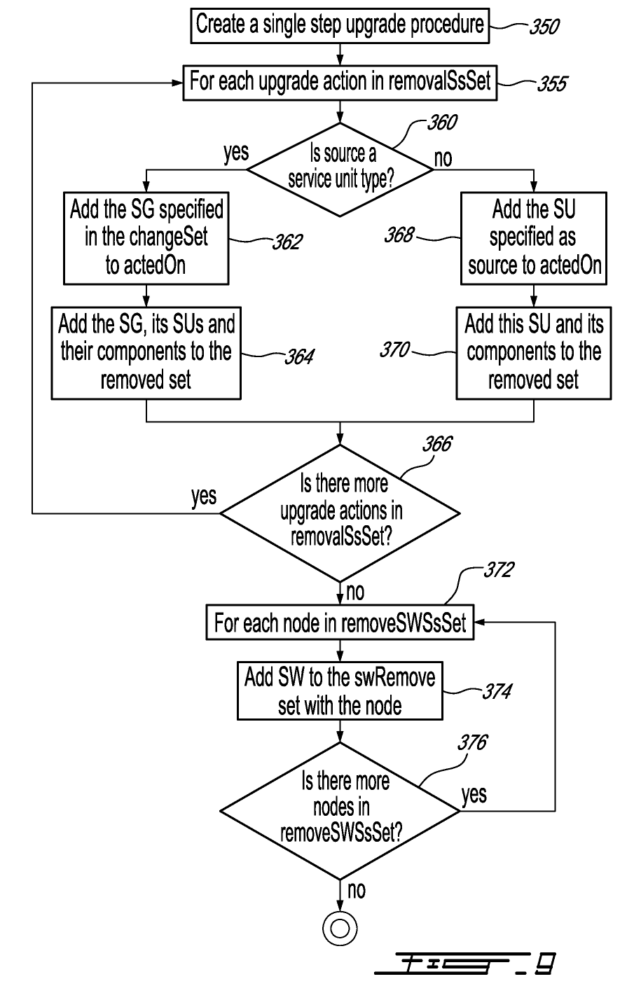

In step 206, the method verifies whether the removalSsSet is empty. If the answer is no, the method advances to step 208, in which a SingleStepRemoval procedure (to be discussed later with regard to FIG. 9) generates the appropriate single step upgrade procedures to remove entities based on the upgrade actions of the input set. If the answer in step 206 is yes, the method advances to step 210, in which the method verifies whether the removalSWRollingSet and the addSWRollingSet are empty. If these two sets are empty, the method advances to step 214. If any of the sets is not empty, the method advances to step 212.

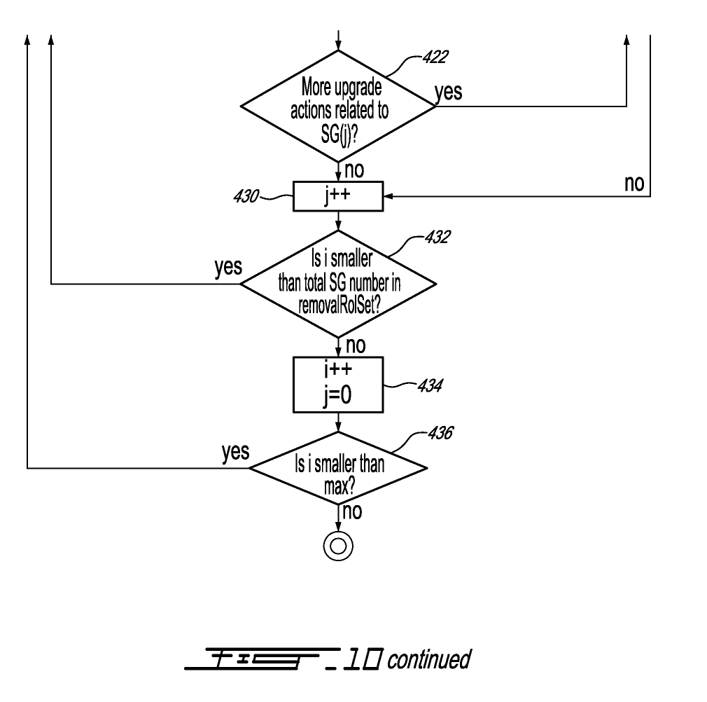

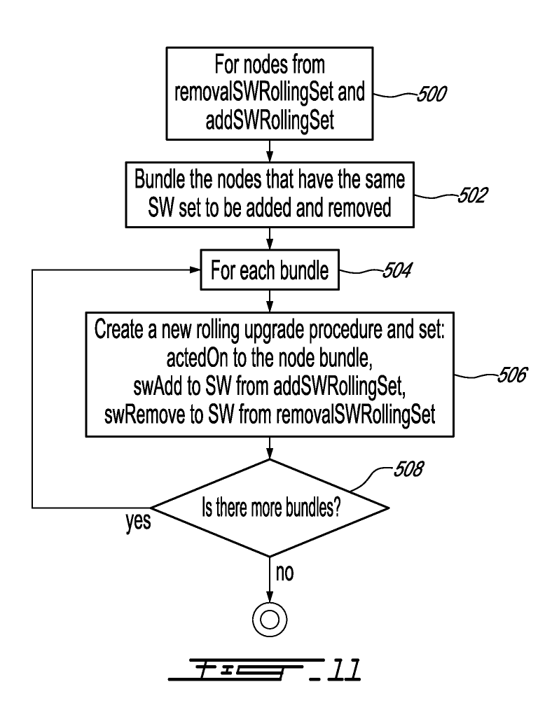

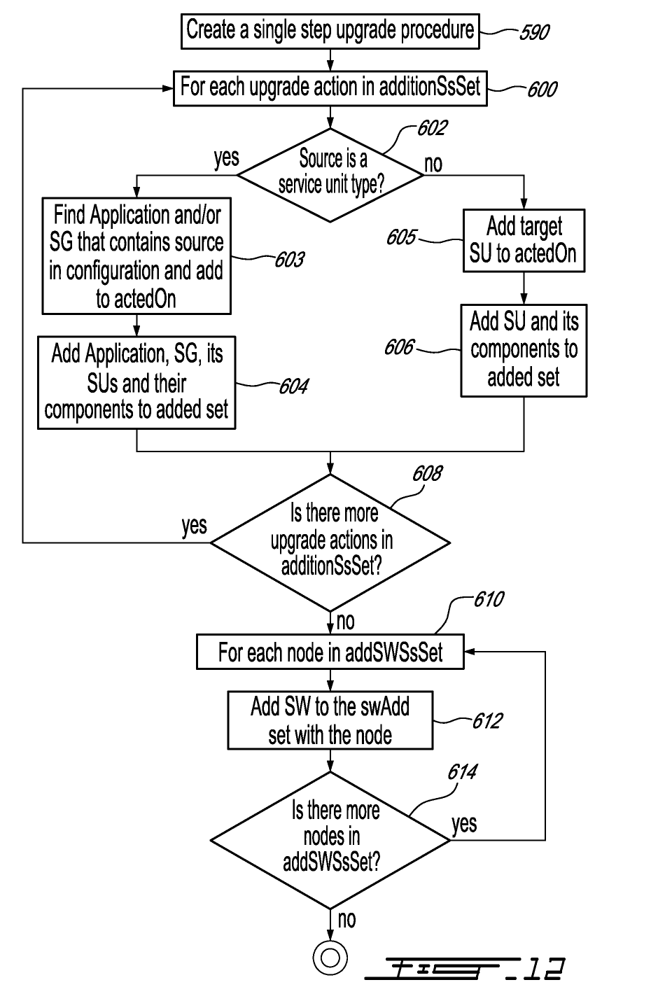

In step 212, a RollingSWUpgrade procedure (to be discussed later with regard to FIG. 11) generates the appropriate rolling upgrade procedures to install and remove software based on the upgrade actions of the input sets. In step 214, the method verifies whether the additionSsSet is empty. If the answer is yes, the method advances to step 218. If the answer is no, the method advances to step 216, in which a SingleStepAddition procedure (to be discussed later with regard to FIG. 12) generates the appropriate single step upgrade procedures to add entities and install software based on the upgrade actions of the input set.

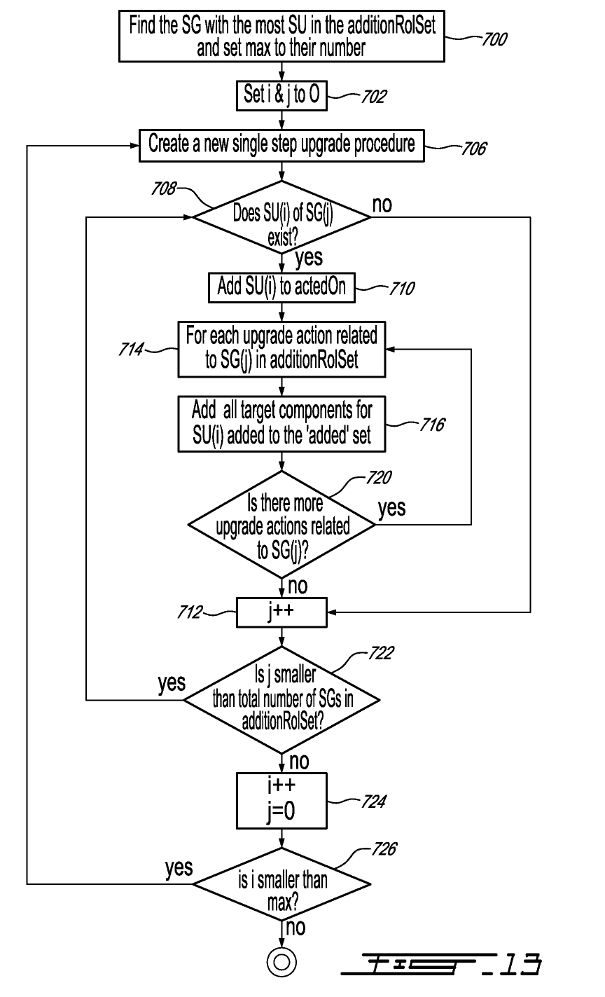

In step 218, the method verifies whether the additionRolSet is empty. If the answer is yes, the method stops. If the answer is no, the method advances to step 220, in which a RollingAdditionToConfig procedure (to be discussed later with regard to FIG. 13) generates the appropriate series of single step upgrade procedures that add components based on the upgrade actions of the input set.

Next, the procedures shown in steps 200, 204, 208, 212, 216, and 220 of FIG. 7 are discussed with regard to FIGS. 8-13. These figures illustrate the generation of different upgrade procedures that need to be part of an upgrade campaign to carry out the configuration changes specified by the different upgrade actions. Some of the parameters of the upgrade procedures referenced in the descriptions are: the ‘actedOn’ parameter specifies the entities taken out of service for an upgrade step of the upgrade procedure; the ‘added’, ‘removed’ parameters of the single step and the ‘modifyTemplate’ parameter of the rolling upgrade procedure specify the actual configuration changes carried out by the upgrade procedure; and the ‘swAdd’ and ‘swRemove’ parameters list the software to be installed and uninstalled. All these parameters may be lists.

FIG. 8 shows an exemplary algorithm that a general computer system may be instructed to perform for performing the functions of the createSetsForSs procedure. Such a computer system (one or more processors, dedicated circuitry or other means as would be understood by those skilled in the art) would become a particular computer system after being programmed based on the algorithm shown in FIG. 8. The same is true for the algorithms shown in the other figures.

The createSetsForSs procedure receives as input the otherActions set, that includes upgrade actions for addition and/or removal. The output of this procedure is eight sets of input actions for generating addition and/or removal procedures. This procedure sorts out the upgrade actions as necessary for the single step upgrade procedure.

In step 300, the procedure selects one upgrade action of the otherActions set. In step 302, the procedure verifies whether the source for the selected upgrade action is empty. If the source is not empty, the procedure advances to step 320. If the source is empty, the procedure advances to step 304, in which the procedure verifies whether the target is a service unit or a service unit type. If the answer to this is no, the procedure advances to step 310. If the answer is yes, the procedure advances to step 306, in which this upgrade action is added to the additionSsSet. Then, the procedure advances to step 308. Returning to step 310, this step adds the upgrade action to additionRolSet, which is a hash set of SG and its related upgrade actions.

The procedure continues to categorize the upgrade actions of the otherActions set, depending on whether and what type of software installation is required in FIG. 8. The software is categorized into software having offline or only online installation portions based on the entities impacted during installation. Accordingly, software requiring only online portions (no entity is impacted) can be installed using a single step upgrade procedure. Otherwise a rolling upgrade procedure is necessary.

For example, if it is determined in step 312 that the software to be installed in a node has an offline portion, an upgrade action for this software is added in step 314 to addSWRolSet set, which is a hash set of each node and its related software. However, if it is determined in step 312 that the software to be installed does not have an offline portion, an upgrade action for the software is added in step 318 to addSWSsSet set, which is a hash set of each node and its related software. Thus, it is noted that for software having an offline portion, this software is installed using a rolling upgrade procedure while for software not having offline portions, the software is installed using a single step upgrade procedure.

Steps 320, 322, and 326 process upgrade actions with source present and target absent, and create sets removalRolSet and removalSsSet. Steps 324, 328, 330, and 332 are similar to steps 308, 312, 314 and 318 discussed above but apply to uninstalling software instead of installing software. In any case, in step 316 if all upgrade actions of the otherAction set have been processed the procedure completes otherwise it returns to step 300.

The SingleStepRemoval procedure is discussed next with regard to FIG. 9. The inputs for this procedure are removalSsSet set, which is a set of upgrade actions for removing service units and service unit types from the configuration, and removeSWSsSet set, which is a set of nodes and related software bundles for removing software in a single step. These two sets are created by the createSetsForSS procedure discussed with regard to FIG. 8.

The output of this procedure includes single step upgrade procedures that remove SUs and any software that can be removed online. The flowchart shown in FIG. 9 includes a step 350, in which a new single step upgrade procedure is created. Next in step 355 an upgrade action is selected from the removalSsSet. In step 360, the procedure determines whether the source is a service unit type. If the answer is no, the procedure advances to step 368. If the answer is yes, the procedure advances to step 362, in which the procedure adds to ‘actedOn’ parameter of the upgrade procedure the SG specified in the ChangeSet. Then, the procedure advances to step 364, in which the SG, its SUs and their components are added to ‘removed’ parameter of the upgrade procedure.

In step 368, the procedure adds to the ‘actedOn’ parameter the SU specified in the source and in step 370 the SU is added to the ‘removed’ parameter together with its components. As a result of step 364 or step 370, the procedure advances to step 366, in which it is determined whether more upgrade actions are in the removalSsSet. If the answer is yes, the algorithm returns to step 355. Otherwise, the algorithm advances to step 372, in which a node in the removeSWSsSet is selected for removing all related software in step 374, i.e. the software is added to the ‘swRemove’ parameter. In step 376 the algorithm verifies whether more nodes are available in removeSWSet. If the answer is yes, the procedure returns to step 372. If the answer is no, the procedure ends.

The RollingRemovalFromConfig procedure is discussed next with regard to FIG. 10. The input of this procedure is set removalRolSet. This set includes the SGs and their related upgrade actions that remove components from the configuration. This set is created by the createSetsForSS procedure discussed with regard to FIG. 8. The output of the RollingRemovalFromConfig procedure includes single step upgrade procedures that remove components. The upgrade procedures presented here may be optimized so that each acts on a set of SUs, each of which belongs to a different SG.

With regard to FIG. 10, in step 400 the procedure determines the SG with the most SU in the removalRolSet and sets max to that number. Then, in step 402, the procedure sets indices “i” and “j” to 0. Step 406 creates a new single step upgrade procedure, for example, generating a single step upgrade procedure, which will be added to the upgrade campaign so that when SMF executes the campaign the actual removal specified in the upgrade action takes place. In step 408, the algorithm determines whether SU(i) of SG(j) in the removalRolSet exists. If the answer is no, the procedure advances to step 430 to increase the value of j. If the answer is yes, the procedure advances to step 410 to add SU(i) to the ‘actedOn’ parameter of the upgrade procedure. In step 412, the algorithm selects an upgrade action related to SG(j) in the removalRolSet and in step 414 the algorithm determines whether the source is a component type. If the answer is no, the algorithm advances to step 424. If the answer is yes, the algorithm advances to step 416, in which a component in SU(i) is selected. In step 418, the algorithm adds the selected component to the ‘removed’ parameter of the upgrade procedure if the type of component is source of the upgrade action. The algorithm advances to step 420, in which it is determined whether more unvisited components are in SU(i). If there are more unvisited components, then the algorithm returns to step 416. If no component more components to visit, the algorithm advances to step 422.

Steps 424, 426 and 428 have the same structure and functions as steps 416, 418 and 420, respectively, except that instead of comparing the component type to the upgrade action's source as in step 418, the ComponentRDN is compared to the source of the upgrade action in step 426.

The algorithm determines in step 422 whether more upgrade actions related to SG(j) exist. If the answer is yes, the algorithm returns to step 412. If the answer is no, the algorithm advances to step 430, and increments j. The algorithm determines whether j is smaller than the number of SGs in removalRolSet in step 432. If the answer is yes, the algorithm returns to step 408. If the answer is no, the algorithm advances to step 434, in which the value of i is increased and j is reset to 0. If the value of i in step 436 is determined to be smaller than max, the algorithm returns to step 404, otherwise the algorithm is terminated.

The RollingSWUpgrade procedure is discussed next with regard to FIG. 11. The inputs of this procedure are sets: removalSWRollingSet, which is a set of nodes and their related software that requires offline removal, and addSWRollingSet, which is a set of nodes and their related software that requires offline installation. These two sets are created by the createSetsForSS procedure discussed with regard to FIG. 8. The output of the RollingSWUpgrade procedure includes rolling upgrade procedures that remove and/or install software offline.

With regard to FIG. 11, in step 500 nodes from removalSWRollingSet and addSWRollingSet sets are identified and in step 502 those nodes that have the same set of software to be added and/or removed are bundled together. In step 504 a bundle is selected and in step 506 one rolling upgrade procedure is created for each node bundle. The ‘actedOn’ is set to those nodes in the bundle which, when the rolling method is applied to these nodes, these nodes indicate that one node at a time will be taken out of service. The ‘swAdd’ and ‘swRemove’ parameters are set, as appropriate, to the set of software common for the node bundle. In step 508, the algorithm determines whether more bundles exist. If the answer is yes, the algorithm returns to step 504. If the answer is no, the algorithm ends.

The SingleStepAddition procedure is discussed next with regard to FIG. 12. The inputs of this procedure are the following sets: additionSsSet, which is a set of upgrade actions for adding SUs to the configuration, and addSWSsSet, which is a set of nodes and related software for installing software in a single step. These two sets are created by the createSetsForSS procedure discussed with regard to FIG. 8. The output of the SingleStepAddition procedure includes single step upgrade procedures that add SUs to the configuration and provide online installation of software.

With regard to FIG. 12, in step 590 a new single step upgrade procedure is created. In step 600 an upgrade action is selected from the additionSsSet and in step 602 it is determined whether the source is a service unit type. If the answer is yes, in step 603 application(s) and SG(s) are added to the ‘actedOn’ parameter of the upgrade procedure as necessary. They are also added to the ‘added’ parameter in step 604 together with the SUs of the SGs and their components. If the answer is no, the SU is added to the ‘actedOn’ parameter in step 605. Then the SU and its components are added to the ‘added’ parameter of the upgrade procedure in step 606. As a result of either step 604 or 606, the algorithm advances to step 608, in which it is determined whether more upgrade actions are in set additionSsSet. If the answer is yes, the algorithm advances returns to step 600. If the answer is no, the algorithm advances to step 610, in which a node from addSWSsSet is selected. In step 612 the software is added to the ‘swAdd’ parameter to be installed on the selected node and in step 614 it is determined whether more nodes are present in set addSWSsSet. If the answer is yes, the algorithm returns to step 608. If the answer is no, the algorithm ends.

The RollingAdditionToConfig procedure is discussed next with regard to FIG. 13. The input of this procedure is set additionRolSet, which is a hash set of SGs and their related upgrade actions set that add components to the configuration. This set is created by the createSetsForSS procedure discussed with regard to FIG. 8. The output of the RollingAdditionToConfig procedure includes single step upgrade procedures that add components.

With regard to FIG. 13, in step 700 the algorithm finds the SG with most SUs in the additionRolSet and sets max to this number. In step 702, indices i and j are set to zero. In step 706, a new single step upgrade procedure is created and in step 708 the algorithm determines whether SU(i) of SG(j) exists. If the answer is no, the algorithm jumps to step 712. If the answer is yes, the algorithm continues to step 710, in which the algorithm adds the SU to the ‘actedOn’ parameter of the upgrade procedure. In step 714, the algorithm selects an upgrade action related to SG(j) from set additionRolSet and in step 716 all target components for SU(i) are added to the ‘added’ parameter of the upgrade procedure. In step 720, the algorithm determines whether more upgrade actions related to SG(j) exists. If the answer is yes, the algorithm returns to step 714. If the answer is no, the algorithm advances to step 712, in which the value of index j is increased. In step 722 the algorithm determines whether the value of j is smaller than the total number of SG in the set additionRolSet. If the value of j is smaller, the algorithm returns to step 708. If the value of j is larger, the algorithm advances to step 724, in which the value of index i is increased and j is reset to 0. In step 726 the value of index i is compared to max. If the value is smaller than max, the algorithm returns to step 706. If the value is not smaller than max, the algorithm stops.

This paragraph concludes the description of the algorithms for the six procedures shown in FIG. 7. Next, the algorithm for the procedure generateRollingUpgradeProcedure introduced in step 68 of FIG. 5 is discussed next with regard to FIG. 14. The input of this procedure is the set rollingAction, which is a set of SGs and their related upgrade actions. The output of the generateRollingUpgradeProcedure procedure includes rolling upgrade procedures that upgrade entity types.

With regard to FIG. 14, in step 800 the SGs (and their upgrade actions) of the rollingAction set are further grouped based on their node groups into bundles. In step 802 a bundle is selected and in step 804 a new rolling upgrade procedure is created and the ‘actedOn’ is set for the node group of the bundle. In step 806 a SG is selected and in step 808 a ‘modifyTemplate’ is created for each of the upgrade actions of the SG. In step 810, the algorithm determines whether there are more SGs in the bundle. If the answer is yes, the algorithm returns to step 806. If the answer is no, the algorithm advances to step 812, in which it is determined whether there are more bundles to process. If the answer is yes, the algorithm returns to step 802. Otherwise the algorithm terminates.

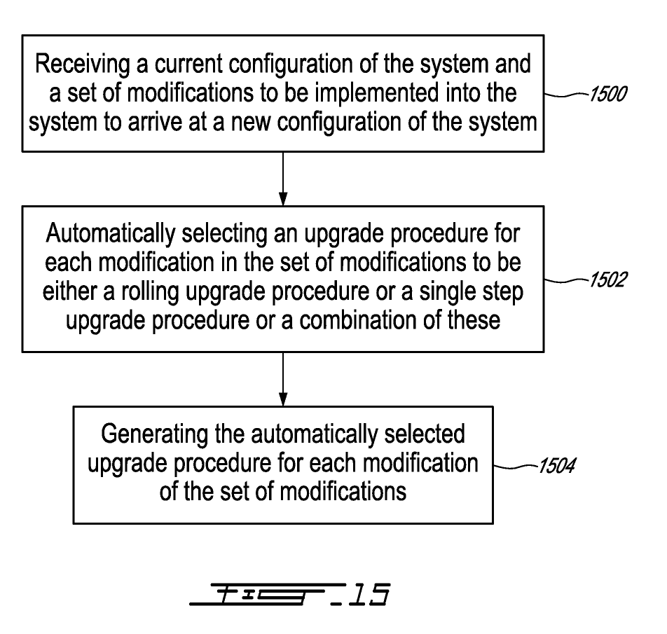

To summarize, a method for generating an upgrade campaign for a system may include the steps shown in FIG. 15. These steps include a step 1500 of receiving a current configuration of the system and a set of modifications to be implemented into the system to arrive at a new configuration of the system, wherein the current configuration includes a configuration of current entities and a configuration of types of the current entities; a step 1502 of automatically selecting an upgrade procedure for each modification in the set of modifications to be either a rolling upgrade procedure or a single step upgrade procedure or a combination of these based on one or more of: the current entities, the types of the current entities, entities of the new configuration, types of the entities of the new configuration, and relationships between the current entities and the entities of the new configuration; and a step 1504 of generating the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.

According to this method, the current entities of the current configuration may include the renewable entities and the obsolete entities, wherein the obsolete entities are present in the current configuration but not in the new configuration, the entities of the new configuration may include the renewed entities and the new entities, wherein the renewed entities are upgrades of the renewable entities of the current configuration and the new entities are added in the new configuration and do not have an equivalent in the current configuration, first modifications may pair the renewable entities of the current configuration to the renewed entities in the new configuration, second modifications may indicate that the obsolete entities are not to be found in the new configuration, and third modifications may indicate that the new entities are added in the new configuration and do not have equivalents in the current configuration.

Optionally, the method may include one or more of the steps of receiving an additional configuration of the system, wherein the additional configuration includes the new entities to be added to the current configuration to arrive at the new configuration and/or new entity types for new and/or for some of the renewed entities of the new configuration, or the step of generating new modifications for some of the current entities that need to be upgraded due to dependencies to the new entities of the new configuration and/or for some of the renewable entities of the current configuration such that renewable and renewed entities are extended, or the step of identifying first entities of the obsolete entities and/or the new entities to be manipulated either by a single step upgrade procedure or by a single step upgrade procedure and additional rolling upgrade procedures or additional single step upgrade procedures, or the step of generating the additional single step upgrade procedures for those first entities that are added to or removed, wherein the additional single step upgrade procedures are ordered in terms of execution.

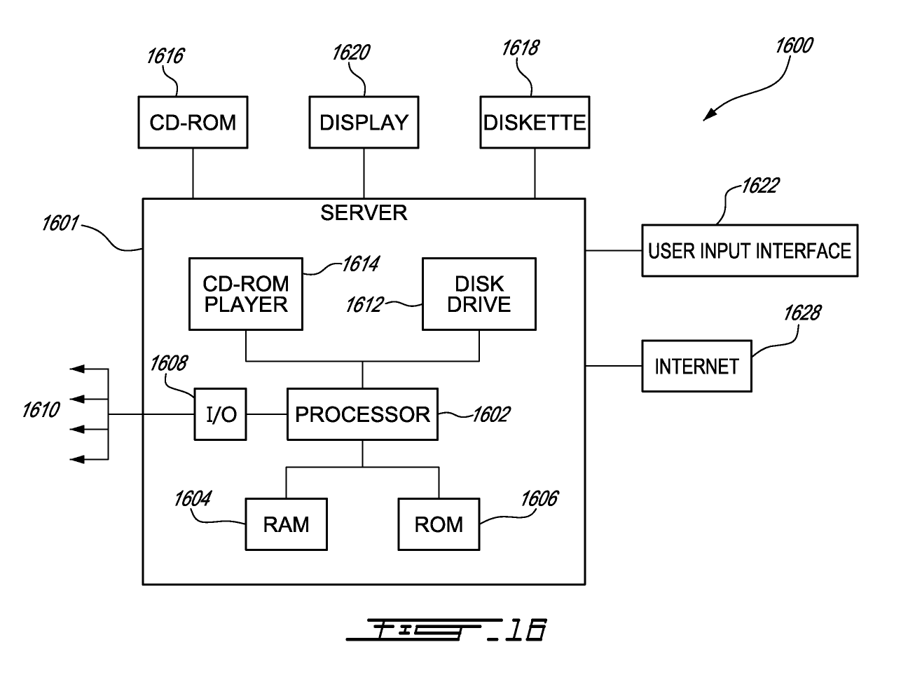

An example of a node of the system (computing arrangement) capable of carrying out operations in accordance with the exemplary embodiments is illustrated in FIG. 16. Although the node may be part of a HA system, the node itself does not have to be a high availability node and/or does not have to be part of a HA system.

The exemplary computing arrangement 1600 suitable for performing the activities described in the exemplary embodiments may include server 1601. Such a server 1601 may include a central processor (CPU) 1602 coupled to a random access memory (RAM) 1604 and to a read-only memory (ROM) 1606. The ROM 1606 may also be other types of storage media to store programs, such as programmable ROM (PROM), erasable PROM (EPROM), etc. The processor 1602 may communicate with other internal and external components through input/output (I/O) circuitry 1608 and bussing 1610, to provide control signals and the like. The processor 1602 carries out a variety of functions as is known in the art, as dictated by software and/or firmware instructions.

The server 1601 may also include one or more data storage devices, including hard and floppy disk drives 1612, CD-ROM drives 1614, and other hardware capable of reading and/or storing information such as DVD, etc. In one embodiment, software for carrying out the above discussed steps may be stored and distributed on a CD-ROM 1616, diskette 1618 or other form of media capable of portably storing information. These storage media may be inserted into, and read by, devices such as the CD-ROM drive 1614, the disk drive 1612, etc. The server 1601 may be coupled to a display 1620, which may be any type of known display or presentation screen, such as LCD displays, plasma display, cathode ray tubes (CRT), etc. A user input interface 1622 is provided, including one or more user interface mechanisms such as a mouse, keyboard, microphone, touch pad, touch screen, voice-recognition system, etc.

The server 1601 may be coupled to other computing devices, such as landline and/or wireless terminals via a network. The server may be part of a larger network configuration as in a global area network (GAN) such as the Internet 1628, which allows ultimate connection to the various landline and/or mobile client devices.

The system 1600 of FIG. 16 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. It is noted that the principles of the present exemplary embodiments are equally applicable to other systems, i.e., mobile computing systems.

The disclosed exemplary embodiments provide a computing system, a method and a computer program product for generating an upgrade campaign. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

What is claimed is:

1. A method for generating an upgrade campaign that includes upgrade procedures for a system, the method comprising:
receiving a current configuration of the system and a set of modifications to be implemented into the system to arrive at a new configuration of the system, wherein the current configuration includes a configuration of current entities and a configuration of types of the current entities;
automatically selecting an upgrade procedure for each modification in the set of modifications to be either a rolling upgrade procedure or a single step upgrade procedure or a combination of these based on one or more of: the current entities, the types of the current entities, entities of the new configuration, types of the entities of the new configuration, and relationships between the current entities and the entities of the new configuration; and
generating the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.

2. The method of claim 1, wherein
the current entities of the current configuration include the renewable entities and the obsolete entities, wherein the obsolete entities are present in the current configuration but not in the new configuration,
the entities of the new configuration include the renewed entities and the new entities, wherein the renewed entities are upgrades of the renewable entities of the current configuration and the new entities are added in the new configuration and do not have an equivalent in the current configuration,
first modifications pair the renewable entities of the current configuration to the renewed entities in the new configuration,
second modifications indicate that the obsolete entities are not to be found in the new configuration, and
third modifications indicate that the new entities are added in the new configuration and the new entities do not have equivalents in the current configuration.

3. The method of claim 1, wherein each modification of the set of modifications is paired with corresponding entities such that (i) first modifications specify relationships between renewable entities and the renewed entities of the new configuration, (ii) second modifications indicate obsolete entities in the current configuration, and/or (iii) third modifications indicate the new entities of the entities of the new configurations that have no equivalent in the current configuration.

4. The method of claim 1, further comprising:
receiving an additional configuration of the system, wherein the additional configuration includes the new entities to be added to the to the current configuration to arrive at the new configuration and/or new entity types for new and/or for some of the renewed entities of the new configuration.

5. The method of claim 1, further comprising:
generating new modifications for some of the current entities that need to be upgraded due to dependencies to the new entities of the new configuration and/or for some of the renewable entities of the current configuration such that renewable and renewed entities are extended.

6. The method of claim 1, further comprising:
identifying first entities of the obsolete entities and/or the new entities to be manipulated either by a single step upgrade procedure or by a single step upgrade procedure and additional rolling upgrade procedures or additional single step upgrade procedures.

7. The method of claim 6, further comprising:
generating the additional single step upgrade procedures for those first entities that are added to or removed, wherein the additional single step upgrade procedures are ordered in terms of execution.

8. The method of claim 6, further comprising:
separating software installation or software removal from addition or removal of an associated entity for those first entities that have software that require offline installation or offline removal.

9. The method of claim 8, further comprising:
generating a rolling upgrade procedure for the software installation or software removal; and
generating a single step upgrade procedure for the entity removal or entity addition.

10. The method of claim 1, wherein the system is a high availability system.

11. The method of claim 1, further comprising:
performing the generating step under rules provided by Service Availability Forum (SAF) specifications while execution of the upgrade procedures are controlled by a Software Management Framework (SMF) of the SAF.

12. The method of claim 1, wherein the system includes components, service units, software, and further comprises:
generating series of single step procedures for modifications that remove components from the current configuration;
generating single step procedures for modifications that remove service units and enclosing entities from the current configuration;
generating rolling procedures for modifications that remove or add software for any entity removed from the current configuration or added to the new configuration using an offline action;
generating single step procedures for modifications that add service units and enclosing entities to the new configuration;
generating series of single step procedures for modifications that add components to the new configuration; and
generating rolling procedures for modifications that change a configuration of existing entities.

13. A computer readable medium including computer executable instructions, wherein the instructions, when executed, implement a method for method for generating an upgrade campaign for a system, the method comprising:
receiving a current configuration of the system and a set of modifications to be implemented into the system to arrive at a new configuration of the system, wherein the current configuration includes a configuration of current entities and a configuration of types of the current entities;
automatically selecting an upgrade procedure for each modification in the set of modifications to be either a rolling upgrade procedure or a single step upgrade procedure or a combination of these based on one or more of: the current entities, the types of the current entities, entities of the new configuration, types of the entities of the new configuration, and relationships between the current entities and the entities of the new configuration; and
generating the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.

14. The medium of claim 13, wherein
the current entities of the current configuration include the renewable entities and the obsolete entities, wherein the obsolete entities are present in the current configuration but not in the new configuration,
the entities of the new configuration include the renewed entities and the new entities, wherein the renewed entities are upgrades of the renewable entities of the current configuration and the new entities are added in the new configuration and do not have an equivalent in the current configuration,
first modifications pair the renewable entities of the current configuration to the renewed entities in the new configuration,
second modifications indicate that the obsolete entities are not to be found in the new configuration, and
third modifications indicate that the new entities are added in the new configuration and do not have equivalents in the current configuration.

15. The medium of claim 13, wherein each modification of the set of modifications is paired with corresponding entities such that (i) first modifications specify relationships between renewable entities and the renewed entities of the new configuration, (ii) second modifications indicate obsolete entities in the current configuration, and/or (iii) third modifications indicate the new entities of the entities of the new configurations that have no equivalent in the current configuration.

16. The medium of claim 13, further comprising:
receiving an additional configuration of the system, wherein the additional configuration includes the new entities to be added to the current configuration to arrive at the new configuration and/or new entity types for new and/or for some of the renewed entities of the new configuration.

17. The medium of claim 13, further comprising:
generating new modifications for some of the current entities that need to be upgraded due to dependencies to the new entities of the new configuration and/or for some of the renewable entities of the current configuration such that renewable and renewed entities are extended.

18. The medium of claim 13, further comprising:
identifying first entities of the obsolete entities and/or the new entities to be manipulated either by a single step upgrade procedure or by a single step upgrade procedure and additional rolling upgrade procedures or additional single step upgrade procedures.

19. The medium of claim 18, further comprising:
generating the additional single step upgrade procedures for those first entities that are added to or removed, wherein the additional single step upgrade procedures are ordered in terms of execution.

20. The medium of claim 18, further comprising:
separating software installation or software removal from addition or removal of an associated entity for those first entities that have software that require offline installation or offline removal.

21. The medium of claim 20, further comprising:
generating a rolling upgrade procedure for the software installation or software removal; and
generating a single step upgrade procedure for the entity removal or entity addition.

22. The medium of claim 13, wherein the system includes components, service units, software, and further comprises:
generating series of single step procedures for modifications that remove components from the current configuration;
generating single step procedures for modifications that remove service units and enclosing entities from the current configuration;
generating rolling procedures for modifications that remove or add software for any entity removed from the current configuration or added to the new configuration using an offline action;
generating single step procedures for modifications that add service units and enclosing entities to the new configuration;
generating series of single step procedures for modifications that add components to the new configuration; and
generating rolling procedures for modifications that change a configuration of existing entities.

23. A node configured to generate an upgrade campaign for a system, wherein the upgrade procedures are executed by a Software Management Framework (SMF), the node comprising:
a processor configured to,
receive a current configuration of the system and a set of modifications to be implemented into the system to arrive at a new configuration of the system, wherein the current configuration includes a configuration of current entities and a configuration of types of the current entities;
automatically select an upgrade procedure for each modification in the set of modifications to be either a rolling upgrade procedure or a single step upgrade procedure or a combination of these based on one or more of: the current entities, the types of the current entities, entities of the new configuration, types of the entities of the new configuration, and relationships between the current entities and the entities of the new configuration; and
generate the automatically selected upgrade procedure for each modification of the set of modifications which, when performed will result in at least one of: renewable entities of the current entities being manipulated to become renewed entities in the new configuration, new entities being added to become part of the entities of the new configuration, and obsolete entities being removed.
